(19) United States
(12) Patent Application Publication
(10) Pub. No.: US 2007/0171604 A1
(43) Pub. Date: Jul. 26, 2007

(54) FOLDABLE ELECTRONIC DEVICE HAVING A LATCH MECHANISM

(75) Inventors: Lin-Yun Hong, Shenzhen (CN); Hsuan-Chen Chen, Tu-Cheng (TW); Chien-Li Tsai, Tu-Cheng (TW); Chun-Chi Liang, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/309,580

(22) Filed: Aug. 25, 2006

(30) Foreign Application Priority Data
Jan. 21, 2006 (CN) 200620054295.1

(51) Int. Cl. G06F 1/16

(52) U.S. Cl. 361/683

(57) ABSTRACT

A latch mechanism for fixing a top member to a base member of a foldable electronic device includes a locking member, an operating member, and a resilient member. The locking member for being pivotably received by the top member of the foldable electronic device includes a locking portion for engaging with the base member of the foldable electronic device. The operating member for being slidably mounted to the top member includes a driving portion to drive the locking member to pivot. The resilient member is for being mounted between the top member of the electronic device and the operating member.

### FIELD OF THE INVENTION

The present invention relates to foldable electronic devices, and particularly to a foldable electronic device having a latch mechanism for readily closing or opening a top member thereof.

### DESCRIPTION OF RELATED ART

A typical foldable electronic device, such as a notebook computer, includes a base member, and a top member with a rear end pivotably mounted to a rear end of the base member by hinges. Generally, the notebook computer includes a latch mechanism mounted to a front side of the top member for fixing the top member to the base member in a closed position.

A conventional latch mechanism is disclosed in U.S. Pat. No. 6,115,239. The latch mechanism includes a sliding member slidably mounted to a top member of a notebook computer, an operating member mounted to the sliding member, and two springs located between corresponding ends of the sliding member and the top member. The sliding member includes a plurality of L-shaped latches protruding down therefrom for engaging with locking holes of a base member of the notebook computer. When opening the top member, the operating member is moved rightward to cause the sliding member to move rightward. Thus, the latches can be disengaged from the locking holes of the base member. However, manipulating the operating member is not easy.

What is desired, therefore, is a foldable electronic device having a latch mechanism which more readily allows opening or closing a top member thereof.

### SUMMARY OF THE INVENTION

An exemplary latch mechanism for fixing a top member to a base member of a foldable electronic device in a closed position includes a locking member, an operating member, and a resilient member. The locking member for being pivotably received by the top member of the foldable electronic device includes a locking portion for engaging with the base member of the foldable electronic device. The operating member for being slidably mounted to the top member includes a driving portion to drive the locking member to pivot. The resilient member is for being mounted between the top member of the electronic device and the operating member.

Other advantages and novel features will become more apparent from the following detailed description when taken in conjunction with the accompanying drawings, in which:

### BRIEF DESCRIPTION OF THE DRAWINGS

FIG. 1 is an exploded, isometric view of a foldable electronic device in accordance with a preferred embodiment of the present invention, the foldable electronic device includes a base member, a cover, a bezel, and a latch mechanism;

FIG. 2 is an enlarged view of a circled portion II of FIG. 1;

FIG. 3 is an exploded, isometric view of the latch mechanism, and a part of the cover of FIG. 1, but an inverted view;

FIG. 4 is an assembled view of FIG. 3;

FIG. 5 is an assembled view of FIG. 1, but partially cutaway, and showing the latch mechanism in a locked state; and

FIG. 6 is similar to FIG. 5, but showing the latch mechanism in an unlocked state.

### DETAILED DESCRIPTION OF THE INVENTION

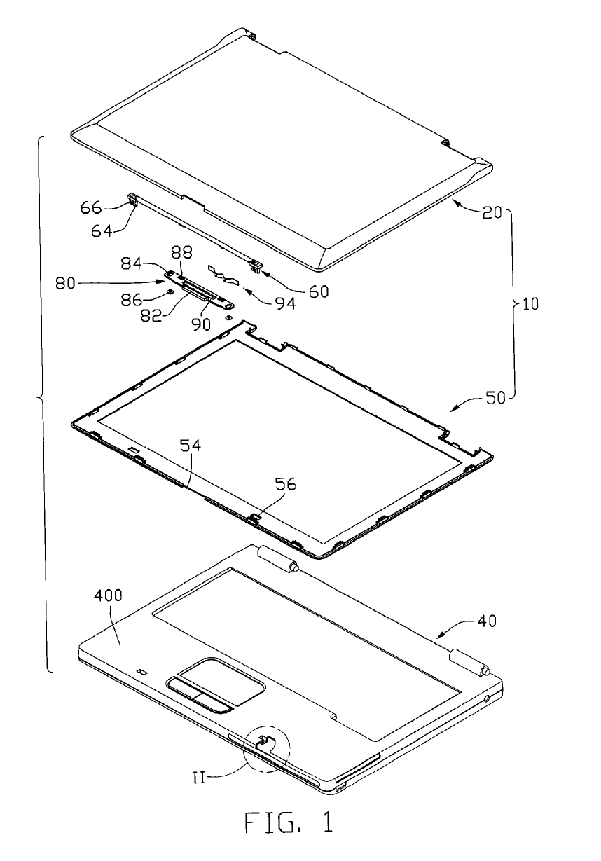

Referring to FIG. 1, a foldable electronic device in accordance with a preferred embodiment of the present invention is shown. The foldable electronic device of this embodiment is a notebook computer. The notebook computer includes a base member 40, a top member 10 pivotably mounted to the base member 40, and a latch mechanism. The top member 10 includes a cover 20, and a bezel 50. The cover 20 and the bezel 50 are for mounting a liquid crystal display panel (not shown) therebetween.

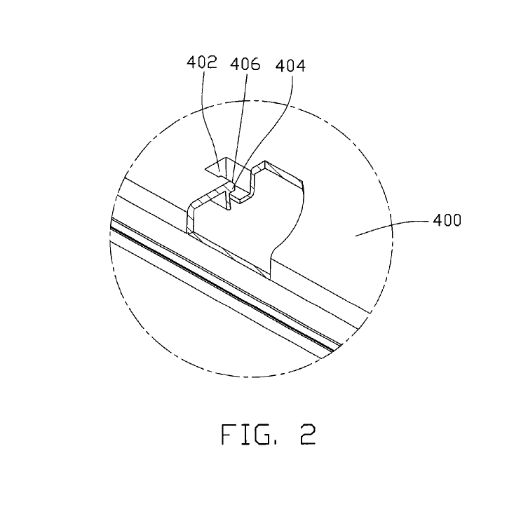

Referring also to FIG. 2, the base member 40 includes a top wall 400. Two recessed portions 402 are defined in the top wall 400 at a front side of the top wall 400. A protrusion 404 protrudes into each recessed portion 402 from a front side of the recessed portion 402. The protrusion 404 has a slanting guiding surface 406 at a top thereof.

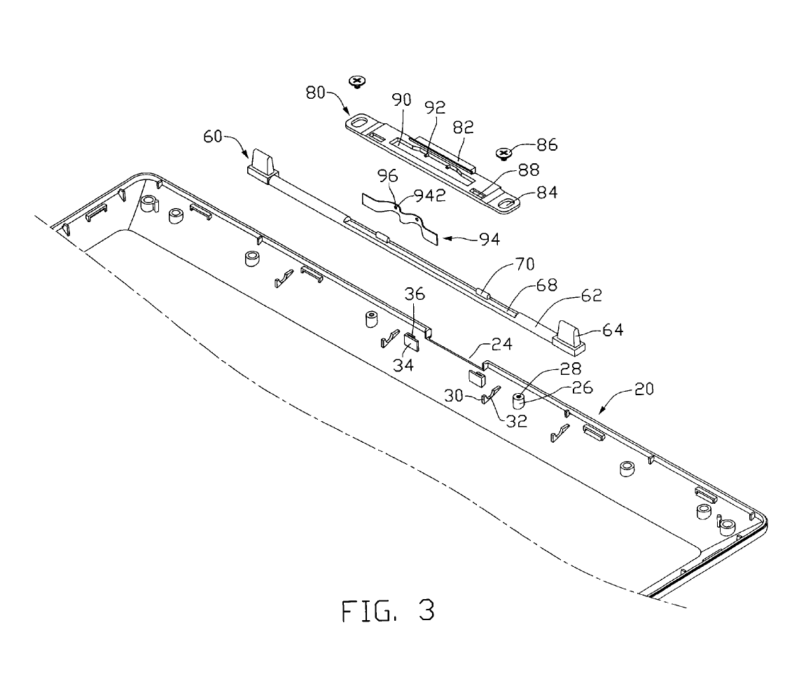

Referring also to FIG. 3, the cover 20 defines a cutout 24 in a middle portion of a front side thereof. A plurality of mounting tabs 30 extends down from the cover 20 and along the front side of the cover 20. Each mounting tab 30 defines a receiving slot 32 therein. A pair of L-shaped locating tabs 34 extends down from the cover 20 adjacent the cutout 24. A receiving space 36 is defined in each locating tab 34. Two cylinders 26 extend down from the cover 20 at opposite sides of the pair of locating tabs 34. Each cylinder 26 defines a mounting hole 28 therein.

The bezel 50 defines two through-holes 56 in a front side thereof, corresponding to the recessed portions 402 of the base member 40. A cutout 54 is defined in a middle portion of the front side of the bezel 50, corresponding to the cutout 24 of the cover 20.

The latch mechanism includes an operating member 80, a resilient member 94, a locking member 60, and two fasteners 86. The operating member 80 defines two sliding slots 84 at opposite sides thereof, an opening 90 in a middle portion thereof, and two through-holes 88 at opposite sides of the opening 90. An operating portion 82 is formed at a front side of the operating member 80. Two mounting posts 92 extend into the opening 90 from the operating member 80 at a front side of the opening 90.

The resilient member 94 is generally M shaped, curved portions of the M designated as two mounting portions 942. A mounting hole 96 is defined in each mounting portion 942.

The locking member 60 includes a long body 62, and two locking portions 64 extending down from opposite ends of the body 62. Each locking portion 64 defines a locking hole 66 therein at a front side thereof. The body 62 defines a depressed portion 68 in a bottom thereof. Two projecting portions 70 extend down from a bottom of the depressed portion 68.

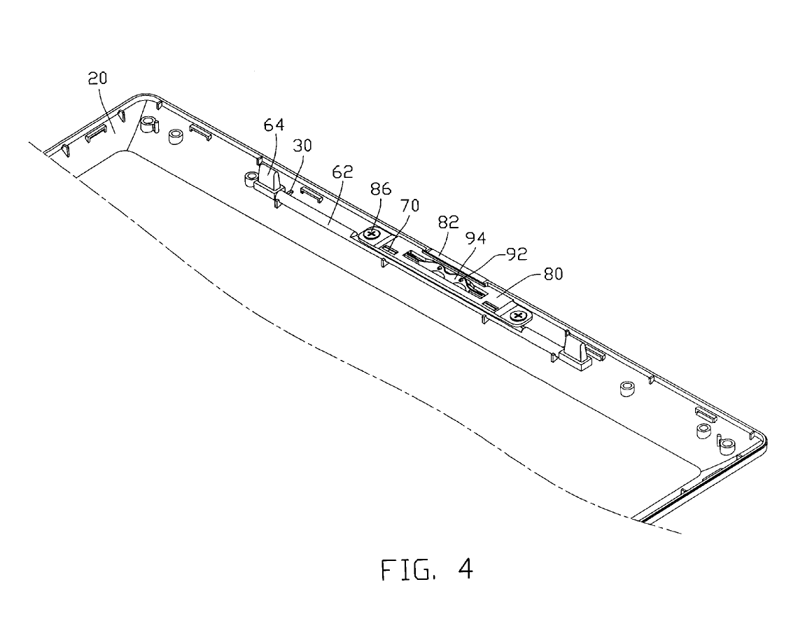

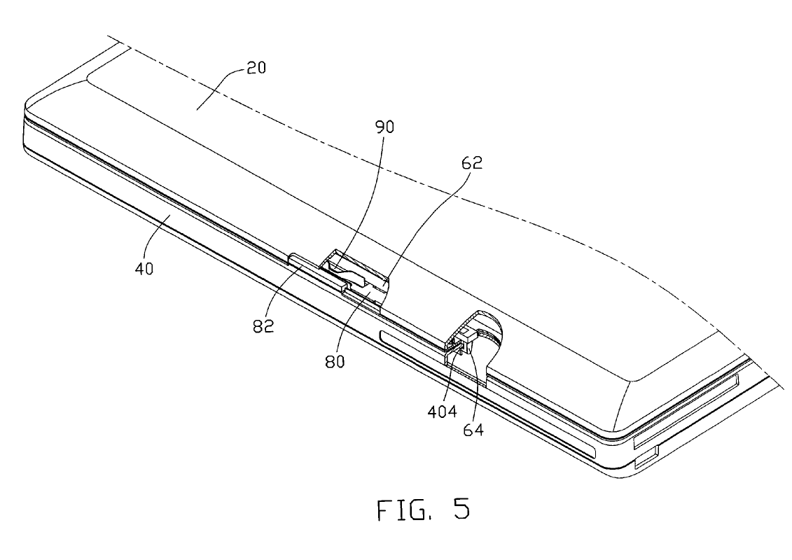

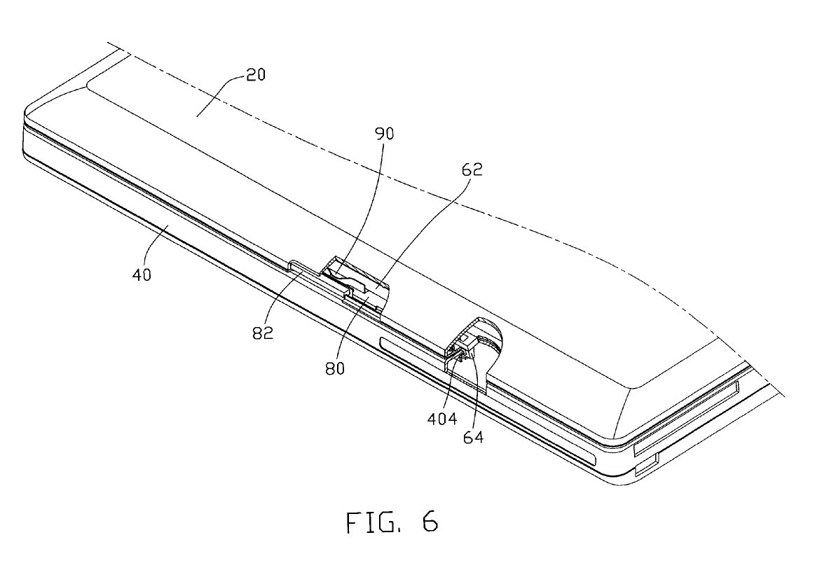

Referring also to FIGS. 4 to 6, in assembling the latch mechanism to the top member 10. The locking member 60 is pivotably received in the receiving slots 32 of the mounting tabs 30. The resilient member 94 is received in the opening 90 of the operating member 80. The mounting holes 96 of the resilient member 94 fit about the corresponding mounting posts 92 of the operating member 80 to mount the resilient member 94 to the operating member 80. The combined assembly of the operating member 80 and the resilient member 94 is attached to the cover 20. Distal ends of the resilient member 94 are received in the receiving spaces 36 of the corresponding locating tabs 34. The through-holes 88 of the operating member 80 movably fit about the corresponding projecting portions 70 of the locking member 60. The sliding slots 84 of the operating member 80 fit about the corresponding cylinders 26 of the cover 20. The operating portion 82 is received in the cutout 24 of the cover 20. Screws 86 are engaged in the mounting holes 28 of the corresponding cylinders 26 to slidably mount the operating member 80 to the cover 20. The bezel 50 is mounted to the cover 20, with the locking portions 64 of the locking member 60 protruding out from the corresponding through-holes 56 of the bezel 50, and the operating portion 82 of the operating member 80 is received in the cutout 54 of the bezel 50. Thus, the latch mechanism is pivotably mounted to the cover 20.

In closing the top member 10 of the notebook computer, the top member 10 is pivoted toward the base member 40. The locking member 60 is pivoted forward when the locking portions 64 touch the corresponding protrusions 404 of the base member 40 and move along the guiding surface 406 of the corresponding protrusions 404. The operating member 80 moves rearward with the locking member 60 via the projecting portions 70. Distal ends of the resilient member 94 are resiliently depressed by the corresponding locating tabs 34 of the covering 20. When the protrusions 404 of the base member 40 align with the corresponding locking holes 66 of the locking member 60, the resilient member 94 is restored to drive the operating member 80 to move back. The locking member 60 is pivoted back. The protrusions 404 of the base member 40 are engaged in the corresponding locking holes 66 of the locking member 60. Thus, the top member 10 is closed.

In opening the top member 10, the operating portion 82 is pressed rearward to cause the operating member 80 to move rearward. Distal ends of the resilient member 94 are resiliently depressed by the corresponding locating tabs 34 of the cover 20. The operating member 80 drives the locking member 60 to pivot. The protrusions 404 of the base member 40 are disengaged from the corresponding locking holes 66 of the locking member 60. Thus, the top member 10 is easily opened.

Additionally, the latch mechanism of the embodiment can be used in other foldable electronic devices, such as a digital video disk (DVD) player.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A latch mechanism for fixing a top member to a base member of a foldable electronic device in a closed position, the latch mechanism comprising:
a locking member for being pivotably received by the top member of the foldable electronic device, the locking member comprising a locking portion for engaging with the base member of the foldable electronic device;
an operating member for being slidably mounted to the top member, the operating member comprising a driving portion to drive the locking member to pivot; and
a resilient member for being mounted between the top member of the foldable electronic device and the operating member.

2. The latch mechanism as claimed in claim 1, wherein the driving portion of the operating member comprises a through-hole defined therein, the locking member further comprises a projecting portion extending down therefrom, for movably engaging in the through-hole of the operating member.

3. The latch mechanism as claimed in claim 1, wherein the resilient member has an M shape, and comprises two mounting portion in a middle part thereof mounted to the operating member, distal ends of the resilient member are for being received by the top member of the foldable electronic device.

4. The latch mechanism as clamed in claim 3, wherein the operating member defines an opening therein, the resilient member is received in the opening, with the mounting portion being mounted to the operating member at a front side of the opening.

5. The latch mechanism as claimed in claim 1, wherein two sliding slots are defined in the operating member at opposite sides for slidably engaging with the top member of the foldable electronic device.

6. The latch mechanism as claimed in claim 1, wherein the locking portion of the locking member extends down from the locking member, the locking portion defines a locking hole therein.

7. The latch mechanism as claimed in claim 1, wherein the operating member further comprises an operating portion at a front side thereof.

8. A foldable device, comprising:
a base member;
a top member, with one end thereof pivotably mounted to a corresponding end of the base member; and
a latch mechanism mounted to an opposite end of the top member, the latch mechanism comprising:
a locking member pivotably received by the top member, the locking member comprising a locking portion for engaging with the base member;
an operating member slidably mounted to the top member, the operating member comprising a driving portion to drive the locking member to pivot; and
a resilient member mounted between the top member and the operating member.

9. The foldable device as claimed in claim 8, wherein the driving portion of the operating member comprises a through-hole defined therein, the locking member comprises a projecting portion extending down therefrom, for movably engaging in the through-hole of the operating member.

10. The foldable device as claimed in claim 8, wherein the resilient member has an M shape, and comprises two mounting portion in a middle part thereof mounted to the operating member, distal ends of the resilient member are received by the top member.

11. The foldable device as claimed in claim 10, wherein the operating member defines an opening therein, the resilient member is received in the opening, with the mounting portion being mounted to the operating member at a front side of the opening.

12. The foldable device as claimed in claim 11, wherein two locating tabs extend down from the top member, each of the locating tabs defines a receiving space therein, the distal ends of the resilient member are received in the receiving spaces of the locating tabs respectively.

13. The foldable device as claimed in claim 8, wherein two sliding slots are defined in the operating member at opposite sides, two cylinders extend down from the top member to be received in the corresponding sliding slots, each of the cylinders defines a mounting hole therein, screws are engaged in the mounting holes to slidably mount the operating member to the top member.

14. The foldable device as claimed in claim 8, wherein the locking portion of the locking member extends down from the locking member, the locking portion defines a locking hole therein, the base member defines a recessed portion therein, a protrusion protrudes into the recessed portion from the base member at a front side of the recessed portion, for engaging with the locking hole of the locking member.

15. The foldable device as claimed in claim 8, wherein the top member defines a first cutout therein, the base member defines a second cutout therein, the operating member further comprises an operating portion at a front side thereof, for being received in the first and second cutouts.

16. The foldable device as claimed in claim 8, wherein a plurality of mounting tabs extends down from the top member, each of the mounting tabs defines a receiving slot therein, the locking member is pivotably received in the receiving slots of the mounting tabs.
